(19) United States
(12) Patent Application Publication
(10) Pub. No.: US 2019/0337199 A1
(43) Pub. Date: Nov. 7, 2019

(54) DEVICE FOR FABRICATING A DENTAL BRACE

(71) Applicant: Elident GmbH, Mettmann (DE)

(72) Inventor: YONG-MIN JO, Duesseldorf (DE)

(21) Appl. No.: 16/403,923

(22) Filed: May 6, 2019

(30) Foreign Application Priority Data
May 7, 2018 (DE) DE202018102517.1

(51) Int. Cl. B29C 43/36; A61C 13/34; B29C 43/50

(52) U.S. Cl. CPC B29C 43/36; B29L 2031/753; B29C 43/50; A61C 13/34

(57) ABSTRACT

A device for producing a dental brace, the device including a tooth model; a brace foil; and a separation foil, wherein the separation foil and the brace foil are jointly deep drawn over the tooth model, wherein the separation foil is arranged between the tooth model and the brace foil and separates the tooth model them from the brace foil, wherein the separation foil includes a free standing gripping portion distal from and not in contact with the tooth model, and wherein the free standing gripping portion is grippable by hand.

### RELATED APPLICATIONS

This application is claims priority from and incorporates by reference German Utility Model 20 2018 102 517.1 filed on May 7, 2018.

### FIELD OF THE INVENTION

The invention relates to a device for fabricating a dental brace, the device comprising a tooth model, a brace foil and a separation foil wherein the separation foil is arranged between the teeth model and the brace foil so that the separation foil separates the tooth model from the brace foil. The separation foil and the brace foil are typically not glued together.

### BACKGROUND OF THE INVENTION

Devices of this generic type are known in the art and are being used to fabricate dental braces. Typically dental braces of this type are used for correcting tooth misalignments. This means the dental braces are intended to move a tooth positioning from an actual condition into a nominal condition.

In order to move the teeth from the actual condition into the nominal condition some teeth have to be moved by up to several millimeters. An individual dental brace, however, can only cause a correction of 0.2 mm to 0.3 mm and therefore typically plural dental braces with different individual shapes have to be used in sequence in order to facilitate a movement of the teeth to be treated from their actual condition to their final nominal condition. Thus, the individual dental braces have to be inserted in a predetermined sequence for typically one to two weeks. Thus, each additional dental brace moves the teeth further and further in a direction towards the nominal condition until the last dental brace moves the teeth into their nominal condition.

During the fabrication process of each individual dental brace initially tooth models are required which reflect corresponding intermediary steps between the actual condition and the nominal condition of the teeth. In order to shape the individual dental braces initially the separation foil and subsequently the brace foil are deep drawn over the respective tooth model. The separation foil is intended to prevent that the brace foil penetrates into the interdental spaces of the tooth model. A penetration of the brace foil into the interdental spaces would have the effect that the brace foil is not removable from the tooth model anymore. After the brace foil is cured the separation foil and the brace foil are initially shortened towards the edge of the tooth model. Typically this is done by pattern drilling or cutting the brace foil. Thereafter the brace foil is removed from the tooth model by levering or pressing. This, however, is a rather time consuming process step since the brace foil has adapted well to the tooth contours and is thus wedged into the tooth model at several corners. After the brace foil is removed from the tooth model the brace foil is processed further so that the brace foil forms the actual brace in a finished condition of the brace foil. For example the brace can be cut out of the brace foil.

The pattern drilling and cutting of the brace foil has not only proven to be time consuming and error prone but can also cause damages to the hardened brace foil. Another disadvantage is that separating the tooth model and the brace foil during retrieval is time consuming and can cause damages to the brace foil and to the brace due to the forces applied.

### BRIEF SUMMARY OF THE INVENTION

Thus, it is an object of the invention to provide a device that facilitates a quicker and more reliable removal of the brace foil from the tooth model.

Improving upon the device described supra the object is achieved by a device for producing a dental brace, the device including a tooth model; a brace foil; and a separation foil, wherein the separation foil and the brace foil are jointly deep drawn over the tooth model, wherein the separation foil is arranged between the tooth model and the brace foil and separates the tooth model them from the brace foil, wherein the separation foil includes a free standing gripping portion distal from and not in contact with the tooth model, and wherein the free standing gripping portion is grippable by hand.

The free standing gripping portion according to the invention can be a portion of the separation foil that protrudes beyond the tooth model and that is large enough so that it can be gripped by hand, advantageously between a thumb and an index finger. The arrangement “remote from the tooth model” thus describes a configuration where the gripping portion is arranged adjacent to the tooth model. Typically the gripping portion extends in a foil plane that terminates flush with a bottom side of the tooth model. The foil plane is the plane of the separation foil or of the brace foil that is defined by the respective foil before deep drawing over the tooth model. The deep drawing shapes the foils so that a negative image of the tooth model protrudes beyond the foil plane at a top side of the foil.

It is particular to the instant invention that the tooth model can be retrieved from the cured brace foil in one process step using the gripping portion of the separation foil. Thus, the gripping portion forms a suitable force application area where the separation foil is grippable independently from the brace foil so that at force is impartible upon the separation foil and the tooth model without simultaneously influencing the brace foil. This facilitates applying forces upon the brace foil and the separation foil that are oriented away from each other which facilitates separating the two foils from each other. Advantageously the brace foil is held with one hand and the separation foil is held with the other hand so that the two foils are separable from each other in a simple manner. Complicated pressing or levering of the tooth model from the brace foil is therefore not required anymore. This saves time and damages to the brace foil can be prevented. Furthermore subsequent trimming of the brace foil is simplified since the tooth model is not present anymore which improves access to the brace foil.

Particularly simple handling is provided when the free standing gripping portion of the separation foil is arranged at distal ends of a jaw of the tooth model. According to the instant application the respective distal ends of the jaw of the tooth model describe the two ends of a tooth arc where the most rearward molars of a jaw are arranged in the respective tooth model wherein the most rearward molars only have one adjacent tooth. This has the advantage that the teeth of the tooth model do not block in the brace foil during a retrieval which would be the case for example when the grip portion is arranged in the portion of the incisors. Namely the incisors are labially inclined, thus towards the lip portion and thus arranged at a slant angle towards the grip portion of the separation foil and at a slant angle to the protruding portion of the separation foil and would interlock in the brace foil during retrieval. The resultant resistance would prevent a retrieval of the tooth model from the brace foil. Alternatively also a grip portion would be conceivable at both portions that include the lateral teeth.

The arrangement of the grip portion of the separation foil at the distal ends of the tooth model has the additional advantage that the force required to retrieve the tooth model together with the separation foil from the brace foil is kept very small since a force transmission only occurs at two points, namely the two distal ends of the tooth model and not only at one end. This constitutes a simplification in particular over the removal process known in the art since a pulling out or levering out of the brace foil can be performed at several points simultaneously and does not only occur at one point.

Due to the arrangement of the free standing grip portion of the separation foil at the distal ends of the jaw of the tooth model material savings can be achieved since the overhanging portion of the separation foil in the portion of the distal ends of the tooth model is the greatest for anatomical reason since a recess is provided in this portion between the two distal ends wherein a protruding portion of the separation foil is automatically provided in the recess due to the fabrication process. Therefore a sufficiently large grip portion of the separation foil is already provided with small material use even when the protrusion of the separation foil is only very small at the remaining tooth model.

When retrieving the tooth model from the separation foil using the separation foil a tearing of the separation foil has to be prevented and therefore the separation foil according to the invention has a tensile strength between 40 MPa and 75 MPa, advantageously between 42 MPa and 70 MPa. Tearing the separation foil would have the effect that the tooth model can only be levered or pressed out of the brace foil with a considerable amount of effort like in the prior art. This shall be prevented by providing the separation foil with a great tear strength.

According to an embodiment of the invention it is provided that a side of the separation foil that is oriented towards the brace foil has a higher roughness than a side of the separation foil that is oriented away from the brace foil. Thus, a roughness of the side of the separation foil that is oriented towards the brace foil shall be high enough so that a connection of the separation foil and the brace foil is provided during deep drawing and so that the connection is disengageable thereafter.

Advantageously the separation foil and the brace foil are deep drawn over the tooth model simultaneously. Consequently an additional fabrication step can be omitted since the separation foil and the brace foil do not have to be deep drawn over the tooth model sequentially, but the deep drawing of the separation foil and the brace foil can be provided in one combined step.

Additionally it is provided that the separation foil is disengageably connected with the brace foil already before the deep drawing. Also according to this method the separation foil as well as the brace foil are deep drawn over the tooth model in one step.

### BRIEF DESCRIPTION OF THE DRAWINGS

The invention is subsequently described in more detail based on an embodiment with reference to drawing figures, wherein:

FIG. 1 illustrates an exploded view of a device according to the invention;

FIG. 2 illustrates a bottom view of the device according to the invention according to FIG. 1; and

FIG. 3 illustrates a side view of the device according to the invention according to FIG. 1.

### DETAILED DESCRIPTION OF THE INVENTION

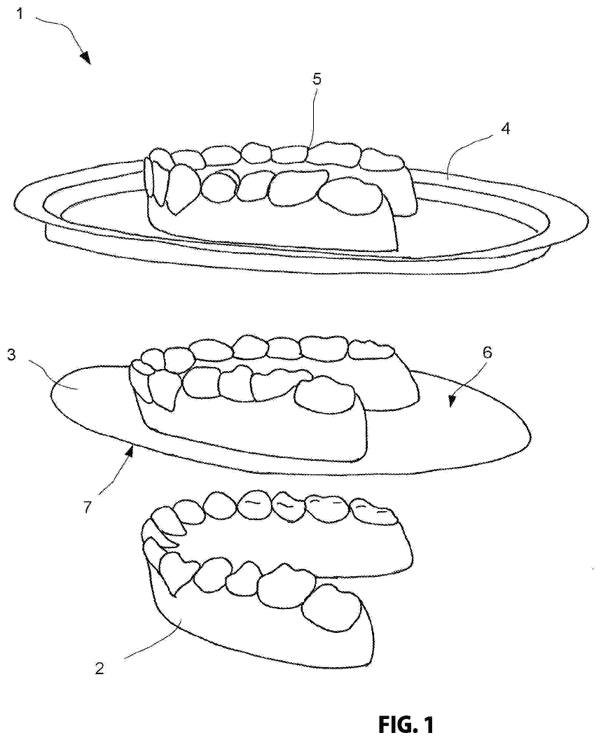

The embodiment illustrated in FIG. 1 in an exploded view includes a device 1 according to the invention with a tooth model 2, a separation foil 3 and a brace foil 4. The separation foil 3 is arranged between the brace foil 4 and the tooth model 2 and thus prevents that the brace foil 4 penetrates into interdental spaces 5 of the tooth model 2 when the brace foil is deep drawn over the tooth model 2. Simultaneously the separation foil 3 facilitates a separation of the brace foil 4 due to a side 6 of the separation foil that is oriented towards the brace foil 4.

In order to produce a dental brace that is not illustrated the brace foil 4 and the separation foil 3 are deep drawn over the tooth model 2. The deep drawing of the brace foil 4 and of the separation foil 3 can be performed sequentially as well as simultaneously. A side 6 of the separation foil 3 that is oriented towards the brace foil 4 has a higher roughness than a side 7 of the separation foil 3 that is oriented away from the brace foil 4, so that the brace foil 4 and the separation foil 3 do not enter into a non disengageable connection during deep drawing.

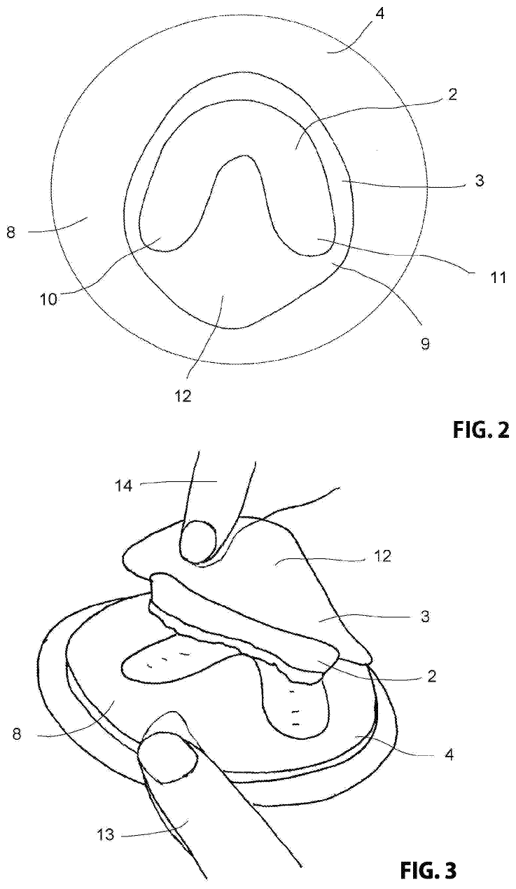

FIG. 2 illustrates the tooth model 2 with a separation foil 3 that is deep drawn over the tooth model 2 and with a brace foil 4 in a bottom view. A curing of the brace foil 4 has already occurred in the illustrated condition. The brace foil 4 and the separation foil 3 overlap the tooth model 2 so that a protruding portion 8 of the brace foil 4 as well as a protruding portion 9 of the separation foil 3 are provided. The portion 9 of the separation foil 3 that protrudes from the distal ends 10, 11 of the tooth model 2 forms a free standing gripping portion 12 according to the invention.

FIG. 3 illustrates the retrieval of the tooth model 2 from the brace foil 4. Thus, it is provided that the brace foil 4 is held by a hand 13 at any point of the protruding portion 8 of the brace foil 4. Another hand 14 grips the gripping portion 12 of the separation foil 3 and pulls it out of the brace foil 4 together with the tooth model 2. In order for the separation foil 3 not to tear while pulling the tooth model 2 out of the brace foil 4 the separation foil 3 has a tensile strength of 50 MPa.

Subsequently a non-illustrated dental brace is fabricated from the brace foil 4, in particular cut out.

### REFERENCE NUMERALS AND DESIGNATIONS

1 device
2 tooth model
3 separation foil
4 brace foil
5 interdental space
6 side
7 side
8 portion
9 portion
10 distal end
11 distal end
12 grip portion
13 hand
14 hand

What is claimed is:

1. A device for producing a dental brace, the device comprising:
a tooth model;
a brace foil; and
a separation foil,
wherein the separation foil and the brace foil are jointly deep drawn over the tooth model,
wherein the separation foil is arranged between the tooth model and the brace foil and separates the tooth model them from the brace foil,
wherein the separation foil includes a free standing gripping portion distal from and not in contact with the tooth model, and
wherein the free standing gripping portion is grippable by hand.

2. The device according to claim 1, wherein the free standing gripping portion of the separation foil is arranged at distal ends of a jaw of the tooth model (2).

3. The device according to claim 1, wherein the separation foil has a tensile strength between 40 MPa and 75 MPa or between 42 MP and 70 MPa.

4. The device according to claim 1, wherein a side of the separation foil that is oriented towards the brace foil has a greater roughness than a side of the separation foil that is oriented away from the brace foil.

5. The device according to claim 1, wherein the separation foil and the brace foil are simultaneously deep drawn over the tooth model.

6. The device according to claim 1, wherein the separation foil is connected with the brace foil in a disengageable manner before the deep drawing.
